(19) United States
(12) Patent Application Publication
(10) Pub. No.: US 2021/0227382 A1
(43) Pub. Date: Jul. 22, 2021

(54) To Increase Security of Dual Connectivity

(71) Applicant: Telefonaktiebolaget LM Ericsson (publ), Stockholm (SE)

(72) Inventors: Monica Wifvesson, LUND (SE); Oumer Teyeb, SOLNA (SE); Noamen Ben Henda, VALLINGBY (SE); Prajwol Kumar Nakarmi, SOLLENTUNA (SE)

(21) Appl. No.: 17/055,189

(22) PCT Filed: May 14, 2019
(86) PCT No.: PCT/EP2019/062320

§ 371 Date: Nov. 13, 2020

Related U.S. Application Data
(60) Provisional application No. 62/671,247, filed on May 14, 2018.

(51) Int. Cl. H04W 12/00; H04W 76/15; H04W 76/27

(52) U.S. Cl. CPC H04W 12/009; H04W 84/18; H04W 76/27; H04W 76/15

(57) ABSTRACT

A method (1400) is performed by a secondary base station (412, 520) in first connection with a wireless device (110) in a dual connectivity. The wireless device has a second connection with a master base station (412, 520). A first security algorithm is used for communication between the secondary base station and the wireless device in the first connection. The method comprises determining to use a second security algorithm for securing communication between the secondary base station and the wireless device. The method further comprises sending a message to the master base station, the message indicating the second security algorithm and causes the master base station to send a message to the wireless device. The message to the wireless device indicates the second security algorithm. The method further comprises using the second security algorithm to secure communication between the secondary base station and the wireless device.

### TECHNICAL FIELD

Certain embodiments of the present disclosure relate, in general, to wireless communications and, more particularly, to dual connectivity.

### BACKGROUND

In wireless communications systems, such as New Radio (NR or 5G) and Long Term Evolution (LTE) wireless communications systems, a wireless device, such as a user equipment (UE), can be simultaneously connected to two or more radio access network nodes, e.g., base stations. The base stations that provide LTE Evolved Universal Terrestrial Radio Access (E-UTRA) Radio Access Technology (RAT) are called evolved NodeBs (eNBs). The eNBs that are connected to 5G core network (5GC) are called new generation eNBs (ng-eNBs). The base station nodes that provide 5G NR RAT are called Next Generation NodeBs (gNBs). The gNBs that are connected to an LTE core network (EPC) are called en-gNBs. The radio access network (RAN) in an LTE system consists of eNBs and en-gNBs. They are connected to the EPC. The RAN in 5G system is called NG-RAN which consists of ng-eNBs and gNBs. The nodes in NG-RAN are connected to the 5GC.

The 3GPP technical specification (TS) 36.300 V15.1.0 defines intra-E-UTRA Dual Connectivity (DC). Security aspects of DC are defined in 3GPP TS 33.401 V15.3.0. 3GPP TS 37.340 V15.1.0 defines multi-RAT dual connectivity (MR-DC). It defines both MR-DC with EPC and MR-DC with 5GC. The following are several variants of MR-DC:
1. The MR-DC with EPC, i.e., the E-UTRA-NR Dual Connectivity (EN-DC). Security aspects of EN-DC are defined in 3GPP TS 33.401 V15.3.0.
2. The MR-DC with 5GC, which has further variants as follows. In both dual connectivity variants, NG-RAN E-UTRA-NR Dual Connectivity (NGEN-DC) and NR-E-UTRA Dual Connectivity (NE-DC), the master node (MN) is connected to the 5GC, and the MN and the secondary node (SN) are inter-connected via the Xn interface.
   2.1. NGEN-DC is where a UE is connected to one ng-eNB that acts as an MN and one gNB that acts as an SN.
   2.2. NE-DC is where a UE is connected to one gNB that acts as an MN and one ng-eNB that acts as an SN.
      The embodiments discussed herein may be described with reference to both cases of EN-DC and MR-DC with 5GC.

The SN modification procedure for EN-DC and MR-DC with 5GC may be initiated either by the MN or by the SN. This procedure is defined in Clause 10.3 in 3GPP TS 37.340 V15.1.0. Certain embodiments disclosed herein will address the SN-initiated SN modification procedure.

Figure 10.3.1-2 in 3GPP TS 37.340 V15.1.0, as shown in FIG. 1, illustrates a signalling diagram of how the SN initiates a modification procedure in EN-DC. In particular, if the SN needs to change the security key used for communications with the UE, the SN includes a Packet Data Convergence Protocol (PDCP) Change Indication in Step 1. The MN may then send a new security key to the SN in Step 2 and reconfigure the UE in Step 4. According to 3GPP TS 37.340 V15.1.0, if only an SN security key is provided in Step 2, the MN does not need to wait for the reception of Step 3 to initiate the Radio Resource Control (RRC) connection reconfiguration procedure (Step 4).

The PDCP Change Indication information element (IE) is used to require the MN to either initiate the security key update or to perform PDCP data recovery towards the UE. The PDCP Change Indication IE is detailed in the table below according to 3GPP TS 37.340 V15.1.0.

| | | | | |
|---|---|---|---|---|
| IE/Group | | | IE Type and | Semantics |
| Name | Presence | Range | Reference | Description |

| | | | |
|---|---|---|---|
| PDCP | M | ENUMERATED | The value of S- |
| Change | | (S-KgNB update | KgNB update |
| Indication | | required, PDCP | required indicates |
| | | data recovery | that the security |
| | | required, . . .) | key in en-gNB |
| | | | needs to be |
| | | | updated. |
| | | | The value of |
| | | | PDCP data |
| | | | recovery required |
| | | | indicates that |
| | | | MeNB needs to |
| | | | perform PDCP |
| | | | data recovery. |

Figure 10.3.2-2 in 3GPP TS 37.340 V15.1.0, as depicted in FIG. 2, shows how the SN initiates the security key modification procedure in MR-DC with SGC. Although the security details are not yet finalized in the 3GPP standard, it is considered that the procedure in MR-DC can use the same mechanism as in EN-DC, e.g., the SN sending some kind of key change indicator to the MN in the Step 1. It is possible that in case of security key change, the MN would not have to wait for Step 3, similar to the procedure described above in EN-DC.

### SUMMARY

There currently exist certain challenges. In one aspect, the SN may want to change not only the security key for the UE, but also the security algorithm for various reasons. For example, the SN might have initially selected null ciphering algorithm, e.g., because of a heavy load or because of some test/debugging occurring during that period of time. After some time period, when the SN is no longer under heavy load or the test/debugging has finished, the SN may want to use another non-null ciphering algorithm, e.g., to increase security of the communications. Conversely, the initial ciphering may be set to a non-null algorithm, but due to overload conditions, the SN may want to change the algorithm to a null ciphering algorithm to free up some processing capacity. In an SN-initiated SN modification procedure, the SN can change the security key as described earlier. But, there is no current mechanism for the SN to also change the security algorithms within this procedure. This represents a fundamental security gap and could lead to security problems. For example, this may enable eavesdropping on communications due to the use of null ciphering algorithms or present other security vulnerabilities due to the continuous use of weak algorithms, etc.

Certain aspects of the present disclosure and their embodiments may provide solutions to these or other challenges. This disclosure provides an efficient methods and systems that enable the SN to initiate a security algorithm change. In certain embodiments, the algorithm change may be enabled by aligning the algorithm change with the security key change during SN-initiated SN modification procedure.

There are, proposed herein, various embodiments which address one or more of the issues disclosed herein. In certain embodiments, a method performed by a secondary node (SN) in a dual connectivity scenario with a wireless device, such as a user equipment (UE), includes determining to change the current security algorithm. The method further includes determining a new security algorithm to use. The method further includes initiating an SN modification procedure with the master node (MN) and indicating the determined new security algorithm to use. In some embodiments, the method further includes using the determined new security algorithm with the UE. In some embodiments, the dual connectivity is one of EN-DC and MR-DC with SGC. In some embodiments, indicating the determined new security algorithms to use includes sending algorithm identifiers. In some embodiments, the algorithm identifiers are sent in an SN modification Required message. In some embodiments, the algorithm identifiers in are sent in a Secondary gNB (SgNB) modification Required message.

In certain embodiments, a method performed by a master node in a dual connectivity scenario with a wireless device, such as a user equipment (UE), includes receiving an indication of security algorithms from a secondary node including an indication of a new security algorithm to use. The method further includes reconfiguring the UE with the received indication of the new security algorithm to use.

According to an embodiment, a method is performed by a secondary base station in first connection with a wireless device in a dual connectivity. The wireless device has a second connection with a master base station. A first security algorithm is used for communication between the secondary base station and the wireless device in the first connection. The method comprises determining to use a second security algorithm for securing communication between the secondary base station and the wireless device. The method further comprises sending a message to the master base station. The message to the master base station indicates the second security algorithm and causes the master base station to send a message to the wireless device. The message to the wireless device indicates the second security algorithm. The method further comprises using the second security algorithm to secure communication between the secondary base station and the wireless device.

According to another embodiment, a secondary base station comprises processing circuitry configured to establish a first connection with a wireless device in a dual connectivity. The wireless device has a second connection with a master base station. A first security algorithm is used for communication between the secondary base station and the wireless device in the first connection. The secondary base station is configured to determine to use a second security algorithm for securing communication between the secondary base station and the wireless device. The secondary base station is further configured to send a message to the master base station. The message to the master base station indicates the second security algorithm and causes the master base station to send a message to the wireless device. The message to the wireless device indicates the second security algorithm. The secondary base station is further configured to use the second security algorithm to secure communication between the secondary base station and the wireless device.

In certain embodiments, the method/secondary base station may have one or more additional and/or optional features, such as one or more of the following:

In particular embodiments, second security algorithm is used for an existing bearer between the wireless device and the secondary base station.

In particular embodiments, the second security algorithm is used for an additional bearer between the wireless device and the secondary base station. The additional bearer being in addition to an existing bearer between the wireless device and the secondary base station.

In particular embodiments, sending the message to the master base station is in response to the secondary base station determining to initiate a security modification.

In particular embodiments, a security modification request is received from the master base station. In response to receiving the security modification request from the master base station, the message from the secondary base station to the master base station is sent (i.e., the message that indicates the second security algorithm and causes the master base station to send the message to the wireless device).

In particular embodiments, in response to receiving the security modification request from the master base station, an indication is sent to the master base station. The indication indicates whether the secondary base station is going to be sending the message to the master base station that indicates the second security algorithm.

In particular embodiments, the dual connectivity is one of EN-DC and MR-DC.

In particular embodiments, the message sent to the master base station is a secondary base station modification required message comprising one or more algorithm identifiers associated with the second security algorithm.

In particular embodiments, the second security algorithm is not the same as the first security algorithm.

In particular embodiments, the second security algorithm is not the same as a security algorithm used in the second connection between the wireless device and the master base station.

According to an embodiment, a method is performed by a master base station in first connection with a wireless device in a dual connectivity. The wireless device has a second connection with a secondary base station. A first security algorithm is used for communication between the secondary base station and the wireless device in the second connection. The method comprises receiving a message from the secondary base station at the master base station. The message from the secondary base station indicates a second security algorithm that the wireless device is to use for securing communication between the secondary base station and the wireless device. The method further comprising sending a message from the master base station to the wireless device. The message from the master base station to the wireless device indicates the second security algorithm that the wireless device is to use for securing communication between the secondary base station and the wireless device.

According to another embodiment, a master base station comprises processing circuitry configured to establish a first connection with a wireless device wireless device in a dual connectivity. The wireless device has a second connection with a secondary base station, and a first security algorithm is used for communication between the secondary base station and the wireless device in the second connection. The master base station is configured to receive a message from the secondary base station at the master base station. The message from the secondary base station indicates a second security algorithm that the wireless device is to use for securing communication between the secondary base station and the wireless device. The master base station is further configured to send a message from the master base station to the wireless device. The message from the master base station to the wireless device indicates the second security algorithm that the wireless device is to use for securing communication between the secondary base station and the wireless device.

In certain embodiments, the method/master base station product may have one or more additional and/or optional features, such as one or more of the following:

In particular embodiments, the second security algorithm is associated with an existing bearer between the wireless device and the secondary base station.

In particular embodiments, the second security algorithm is associated with an additional bearer between the wireless device and the secondary base station. The additional bearer being in addition to an existing bearer between the wireless device and the secondary base station.

In particular embodiments, a security modification request is sent from the master base station to the secondary base station and the master base station waits to reconfigure the wireless device until after receiving an acknowledgement of the security modification request from the secondary base station. If the wireless device is to use the second security algorithm for securing communication between the secondary base station and the wireless device, the acknowledgement comprises the message from the secondary base station indicating the second security algorithm. The wireless device is reconfigured by the master base station after receiving the acknowledgement.

In particular embodiments, a security modification request is sent to the secondary base station and the wireless device is reconfigured by the master base station after sending the security modification request (without waiting for an acknowledgement of the security modification request from the secondary base station). The acknowledgement of the security modification request is then received from the secondary base station, and it indicates the second security algorithm. The wireless device is reconfigured again by the master base station after receiving the acknowledgement.

In particular embodiments, a security modification request is sent from the master base station to the secondary base station, and the master base station receives an indication from the secondary base station that indicates whether the secondary base station is going to be sending the message indicating the second security algorithm that the wireless device is to use for securing communication between the secondary base station and the wireless device. The master base station reconfigures the wireless device by either waiting or not waiting for the message from the secondary base station, the waiting or not waiting depending on the indication whether the secondary base station is going to be sending the message.

In particular embodiments, the dual connectivity is one EN-DC and MR-DC.

In particular embodiments, the message received from the secondary base station is a secondary base station modification required message comprising one or more algorithm identifiers associated with the second security algorithm.

In particular embodiments, the second security algorithm is not the same as the first security algorithm.

In particular embodiments, wherein the second security algorithm is not the same as a security algorithm used in the first connection between the wireless device and the master base station.

According to an embodiment, a method is performed by a wireless device in dual connectivity with a master base station and a secondary base station. The wireless device has a first connection with the master base station and a second connection with the secondary base station. A first security algorithm is used for communication between the secondary base station and the wireless device in the second connection. The method comprises using a first security algorithm to secure communication with the secondary base station. The method further comprises receiving a message from the master base station. The message from the master base station indicates a second security algorithm for securing communication between the wireless device and the secondary base station. The method further comprises using the second security algorithm to secure communication between the secondary base station and the wireless device.

According to yet another embodiment, a wireless device comprises processing circuitry configured to establish dual connectivity with a master base station and a secondary base station. The wireless device has a first connection with the master base station and a second connection with the secondary base station. The wireless device is configured to use a first security algorithm to secure communication with the secondary base station. The wireless device is further configured to receive a message from the master base station. The message from the master base station indicates a second security algorithm for securing communication between the wireless device and the secondary base station. The wireless device is further configured to use the second security algorithm to secure communication between the secondary base station and the wireless device.

In certain embodiments, the method/wireless device may have one or more additional and/or optional features, such as one or more of the following:

In particular embodiments, the second security algorithm is used for an existing bearer between the wireless device and the secondary base station.

In particular embodiments, the second security algorithm is used for an additional bearer between the wireless device and the secondary base station. The additional bearer being in addition to an existing bearer between the wireless device and the secondary base station.

In particular embodiments, the dual connectivity is one of EN-DC and MR-DC.

In particular embodiments, the message from the master base station comprises an RRC reconfiguration message. The RRC reconfiguration message comprises one or more algorithm identifiers associated with the second security algorithm.

In particular embodiments, the second security algorithm is not the same as the first security algorithm.

In particular embodiments, the second security algorithm is not the same as a security algorithm used in the first connection between the wireless device and the master base station.

Certain embodiments may provide one or more of the following technical advantages. For example, certain embodiments, enable the secondary node to initiate a security algorithm change within the SN modification procedure. As a result, the secondary node may use the optimal security algorithm without requiring the master node to initiate the security algorithm change. As another example, certain embodiments incorporate the security algorithm change messaging to be incorporated into existing security key messaging. This may result in an efficient procedure by reducing the number of messages or re-running of procedures.

### BRIEF DESCRIPTION OF THE DRAWINGS

For a more complete understanding of the disclosed embodiments and their features and advantages, reference is now made to the following description, taking in conjunction with the accompanying drawings, in which:

FIG. 1 illustrates an example signalling diagram for a secondary node security key modification procedure in E-UTRA-NR Dual Connectivity (EN-DC), in accordance with certain embodiments;

FIG. 2 illustrates an example signalling diagram for a secondary node security key modification procedure in NG-RAN E-UTRA-NR Dual Connectivity (NGEN-DC) or NR-E-UTRA Dual Connectivity (NE-DC), in accordance with certain embodiments;

FIG. 3 illustrates an example signalling diagram for secondary node security algorithm modification procedure in EN-DC, in accordance with certain embodiments;

FIG. 4 illustrates an example signalling diagram for secondary node security algorithm modification procedure in NGEN-DC or NE-DC, in accordance with certain embodiments;

FIG. 5 illustrates an example wireless network, in accordance with certain embodiments;

FIG. 6 illustrates an example user equipment, in accordance with certain embodiments;

FIG. 7 illustrates an example virtualization environment, in accordance with certain embodiments;

FIG. 8 illustrate an example telecommunication network connected via an intermediate network to a host computer, in accordance with certain embodiments;

FIG. 9 illustrates an example host computer communicating via a base station with a user equipment over a partially wireless connection, in accordance with certain embodiments;

FIG. 10 is a flowchart illustrating an example method implemented in a communication system, in accordance certain embodiments;

FIG. 11 is a flowchart illustrating a second example method implemented in a communication system, in accordance with certain embodiments;

FIG. 12 is a flowchart illustrating a third method implemented in a communication system, in accordance with certain embodiments;

FIG. 13 is a flowchart illustrating a fourth method implemented in a communication system, in accordance with certain embodiments;

FIG. 14 is a flowchart illustrating a method implemented in a secondary node of a dual connectivity wireless system, in accordance with certain embodiments;

FIG. 15 is an example virtualization apparatus for a dual connectivity wireless system, in accordance with certain embodiments;

FIG. 16 is a flowchart illustrating a method implemented in a master node of a dual connectivity wireless system, in accordance with certain embodiments;

FIG. 17 is another example virtualization apparatus for a dual connectivity wireless system, in accordance with certain embodiments;

FIG. 18 is a flowchart illustrating a method performed by a secondary base station, in accordance with certain embodiments;

FIG. 19 is a flowchart illustrating a method performed by a master base station, in accordance with certain embodiments;

FIG. 20 is a flowchart illustrating a method performed by a wireless device, in accordance with certain embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

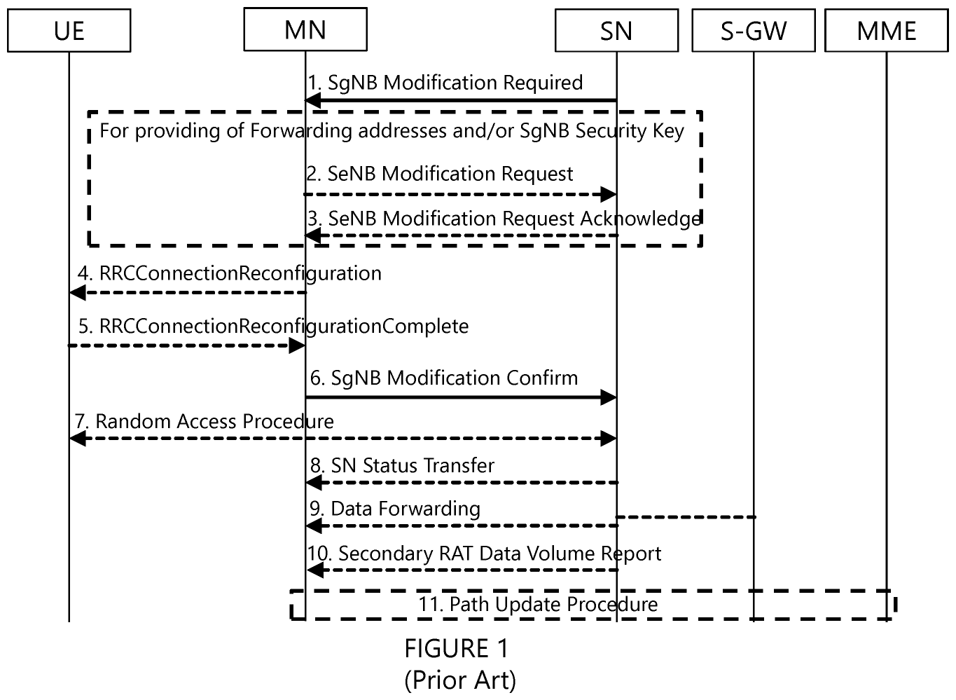

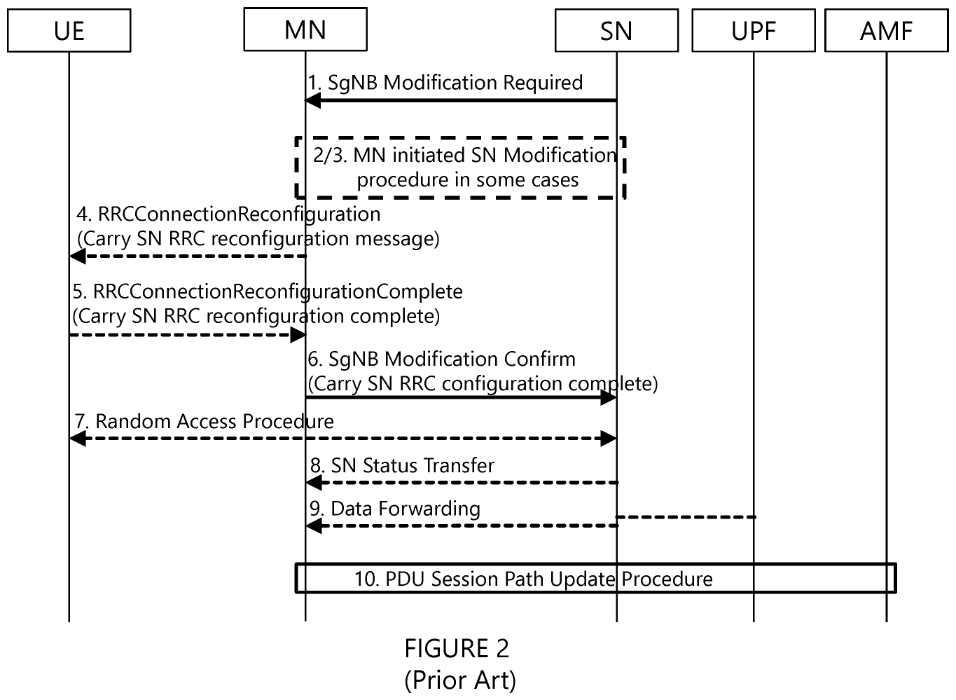

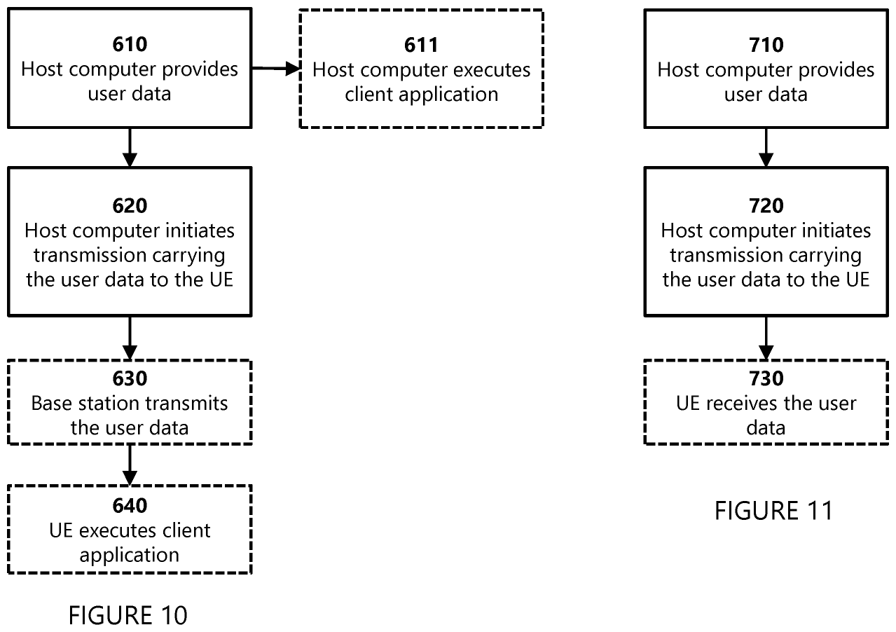

As described earlier, in both EN-DC and MR-DC with SGC, there are no current methods or systems in which the SN can initiate change of security algorithms. As mentioned above, this can create a security issue. For example, if the SN is unable to initiate a change from null ciphering (or other weak or weaker algorithms), communications with the SN may be vulnerable to eavesdropping and/or other vulnerabilities. Certain embodiments may remedy this security deficiency by modifying certain steps depicted in FIGS. 1 and 2, i.e., figures 10.3.1-2 and Figure 10.3.2-2 from 3GPP TS 37.340 V15.1.0. However, this disclosure is not limited to those two 3GPP signalling flows. Certain embodiments apply to other wireless communications systems with dual connectivity.

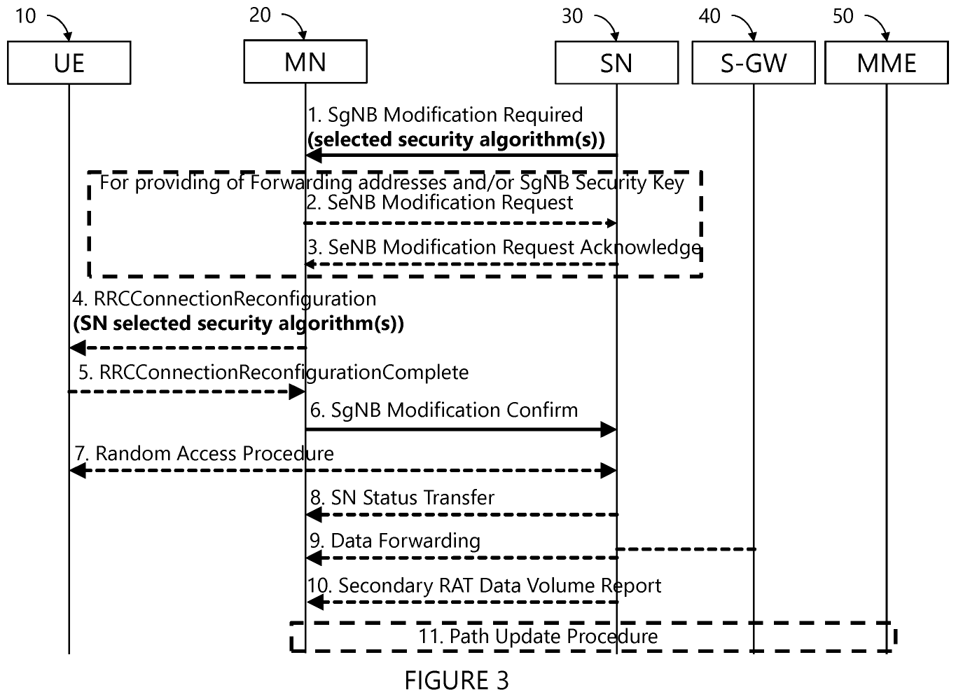

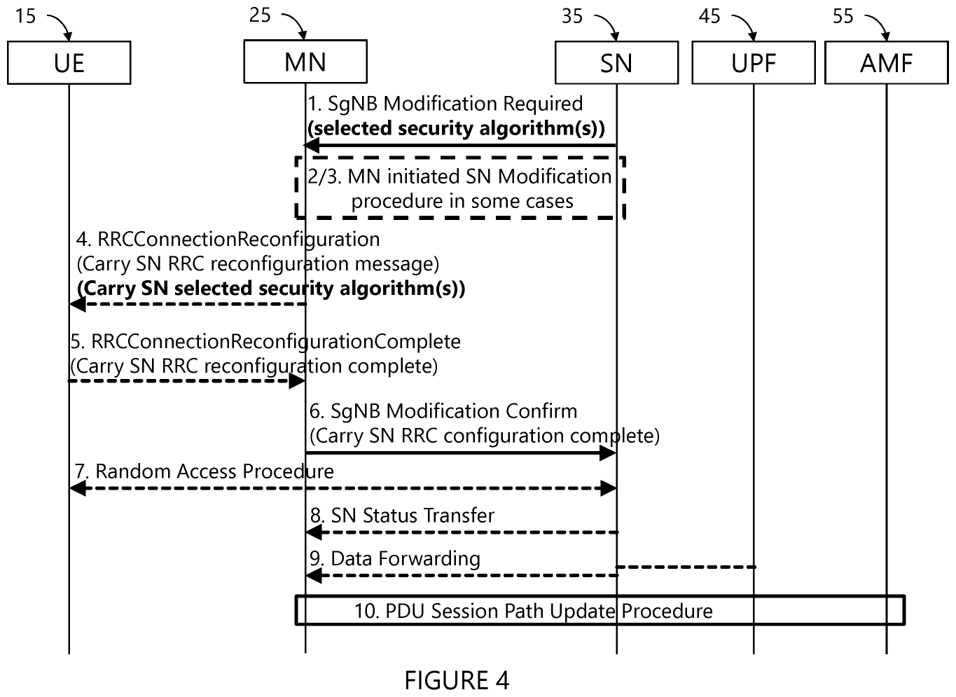

According to a first set of embodiments, the SN (such as SN 30 of FIG. 3 and/or SN 35 of FIG. 4) may indicate a change in the security algorithms to the MN (such as MN 20 of FIG. 3 and/or MN 25 of FIG. 3) (e.g., by sending a message to MN indicating a desired change of the security algorithm). In some embodiments, MN waits for Step 3, the SN acknowledging the SeNB modification, before performing Step 4, reconfiguring the UE (such as UE 10 of FIG. 3 and/or UE 15 of FIG. 4). As a result, the SN may send or indicate new security algorithms in Step 3 if it has not already indicated the security algorithms in Step 1. The MN can then convey these algorithms to the UE during the reconfiguration starting with Step 4.

As shown further in FIG. 3, UE 10 may confirm the reconfiguration with the new security algorithm, which may be confirmed by MN 20 to SN 30. Accordingly, the UE may communicate with SN 30 according to the new security algorithm, e.g., via a random access procedure (as shown in step 7). In this manner, dual-connected SN 30 may initiate the update of a security algorithm.

There may be several further challenges. For example, in certain embodiments, the MN 20, 25 may not be able to quickly initiate RRC connection reconfiguration procedure, as discussed above with the SN-initiated security key modification procedure, because it would have to wait for the SN 30, 35 to convey the security algorithms in Step 3. In some embodiments, SN 30, 35 has no new algorithms to communicate and the wait time by MN 20, 25 is unnecessary. As another example, SN 30, 35 may have communicated all the necessary information in Step 1 and have no information to send in Step 3 that would change the MN 20, 25's Step 4 message to UE 10, 15.

In a second set of embodiments, the optimization for the security key change procedure is maintained. In particular, according to certain embodiments, MN 20, 25 may still quickly initiate RRC connection reconfiguration procedure without waiting for Step 3. In this set of embodiments, if SN 30, 35 sends new security algorithms in Step 3 received after MN 20, 25 initiates the RRC connection reconfiguration procedure, MN 20, 25 may be required to re-initiate the RRC connection reconfiguration procedure. The security algorithm may be changed via handover, which is also referred to as reconfiguration with sync in the context of NR.

The second set of embodiments may result in some inefficiencies by having redundant RRC connection reconfiguration procedures. For example, the RRC connection reconfiguration procedure occurs over-the-air and reconfiguration with sync is an expensive procedure that involves several messages, including random access.

In a third set of embodiments, an improvement on the techniques mentioned above is provided. In this third set of embodiments, SN 30, 35 may indicate to MN 20, 25 if SN 30, 35 has new algorithms to select. If so indicated, MN 20, 25 may respond by waiting for Step 3. Otherwise, in not so indicated, MN 20, 25 may quickly initiate the RRC connection reconfiguration procedure without waiting. This may improve on the possible inefficiencies described above in the first and second sets of embodiments by selectively waiting for Step 3 only when there is a new security algorithm to be used, thereby reducing redundant RRC connection reconfiguration procedures.

In a fourth set of embodiments, systems and methods are provided that further improve on the techniques described above. According to the fourth set of embodiments, SN 30, 35 sends the new security algorithms in Step 1, e.g., when the SN indicates to MN 20, 25 that a security modification is requested. In this manner MN 20, 25 already knows that SN 30, 35 wants to change the algorithms and in addition to that, MN 20, 25 has already received the algorithms to convey to the UE in Step 4. Thus, MN 20, 25 would not have to wait for Step 3, thereby maintaining the optimization allowing for quick initiation of the RRC connection reconfiguration. Further, this set of embodiments avoids redundant RRC connection reconfiguration procedures over-the-air.

Examples from the fourth set of embodiments are illustrated in FIGS. 3 and 4, which are depicted as modifications of FIGS. 1 and 2 (i.e., Figure 10.3.1-2 and Figure 10.3.2-2 from 3GPP TS 37.340 V15.1.0). FIG. 3 illustrates an example signalling diagram for secondary node security algorithm modification procedure in EN-DC, in accordance with certain embodiments. As described herein, the secondary node (SN 30) may indicate to the master node a modification of the security algorithm. The indication may further include a chosen new security algorithm. In this manner, the master node (MN 20) may proceed to step 4 in communicating an RRCConnectionReconfiguration message to the user equipment without waiting for the Modification Request Acknowledgment from the secondary node.

FIG. 4 illustrates an example signalling diagram for secondary node (SN 35) security algorithm modification procedure in NGEN-DC or NE-DC, in accordance with certain embodiments. Similar to the procedure described in FIG. 3, SN 35 may initiate the change of security algorithms in step 1 by sending an indication to the MN 25 with the selected security algorithms. In some embodiments, MN 25 initiates the change of security algorithms at SN 35, e.g., in response to a changed network environment and/or a change of algorithm with UE 15 with MN 25 or another node.

For both signalling procedures described above in the examples illustrated in FIGS. 3 and 4, UE 10, 15 may confirm its reconfiguration with the new security algorithm for SN 30, 35, which may be forwarded from MN 20, 25 to SN 30, 35 in a message (as shown in step 6). UE 10, 15 may carry out a procedure to establish a connection with the new security algorithm(s) to the SN 30, 35, e.g., a random access procedure, as shown in steps 7. Once communication has been established, SN 30, 35 may communicate with other functions of the network, such as the Serving Gateway (S-GW) 40, Mobility Management Entity (MME) 50, User Plane Function (UPF) 45 and/or Access and Mobility Management Function (AMF) 55, to receive data to forward and update information about the session path between the UE 10, 15 and SN 30, 35.

Certain embodiments above may be implemented by introducing a new information element (IE) in the SN modification required message, e.g., messages 1 in FIGS. 3 and 4, to indicate a selected new security algorithm. Other embodiments may only include an indication, e.g., a flag, indicating the algorithm is to be changed, rather than the algorithm itself. In certain embodiments, the new security algorithms may be included in the SCG-Config IE that contains the SCG configuration to be sent to the UE. For example, the PDCP Change Indication IE may be modified, as shown below, instead of introducing a new IE.

| | | | | |
|---|---|---|---|---|
| IE/Group | | | IE Type and | Semantics |
| Name | Presence | Range | Reference | Description |

| | | | |
|---|---|---|---|
| PDCP | M | ENUMERATED | The value of S- |
| Change | | (S-KgNB update | KgNB update |
| Indication | | required, PDCP | required indicates |
| | | data recovery | that the security |
| | | required, security | key in en-gNB |
| | | algorithm update | needs to be |
| | | required, . . .) | updated. |
| | | | The value of PDCP |
| | | | data recovery |
| | | | required indicates |
| | | | that MeNB needs to |
| | | | perform PDCP data |
| | | | recovery. |
| | | | The value of |
| | | | security |
| | | | algorithm update |
| | | | required indicates |
| | | | that the security |
| | | | algorithm is going. |

For example, when the SN, e.g., SN 30 or 35, wants to change the security algorithm, it may set the PDCP Change Indication IE in the SN modification required message to “security algorithm update required”. Though in the above example the PDCP change indication can take only one value, in certain embodiments, the S-KgNB update required and security algorithm update required flags can be set together.

In certain embodiments, the security algorithm update required flag can be implicitly taken also as an indication of the S-KgNB update required procedure. For example, if the security algorithm update required indication is present, the MN may assume that the S-KgNB must also be updated.

In yet further embodiments, the MN, e.g., MN 20 or 25, doesn't necessarily wait for the message in Step 3 to send the reconfiguration in Step 4 to the UE, e.g., UE 10 or 15, if the PDCP change indication flag is set to “security algorithm update.” For example, in certain embodiments, the new security algorithm is already included in the SCG-Config IE that contains the SCG configuration to be sent to the UE.

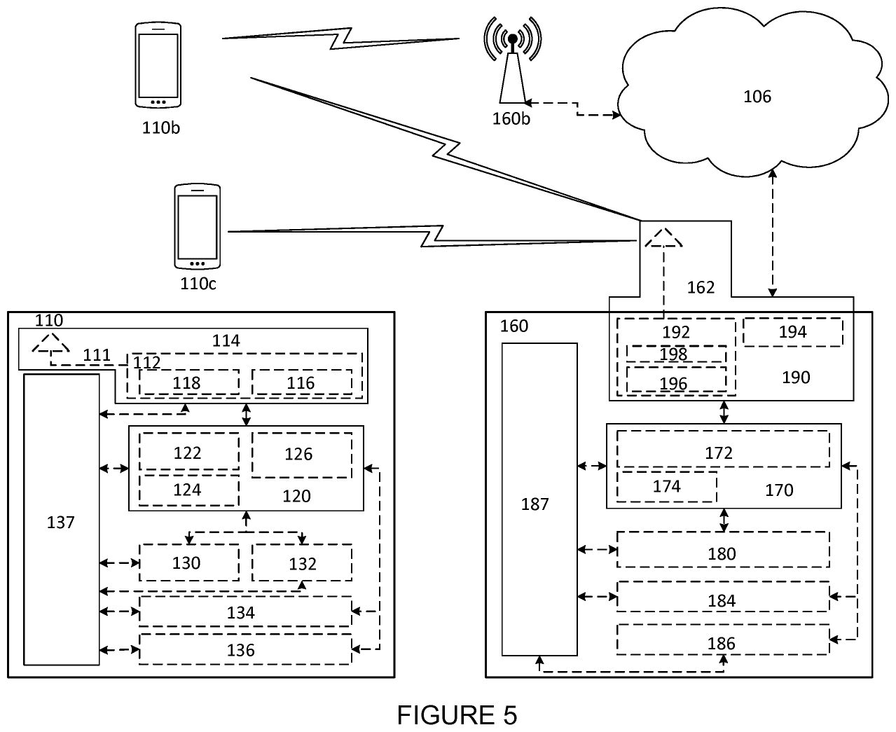

Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

According to certain embodiments, SN 20, 25 and MN 30, 35 may each be implemented by a network node, such as network node 160, as described herein. For example, each of SN 20, 25 and MN 30, 35 may each be implemented as a base station (e.g., radio base stations, Node Bs, evolved Node Bs (eNBs) and NR NodeBs (gNBs)). In certain embodiments, SN 20 and MN 30 (and/or SN 25 and MN 35) are implemented by the same type of network node. Alternatively, SN 20 and MN 30 (and/or SN 25 and MN 35) are implemented by different types of network nodes.

In FIG. 5, network node 160 includes processing circuitry 170, device readable medium 180, interface 190, auxiliary equipment 184, power source 186, power circuitry 187, and antenna 162. Although network node 160 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 5 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

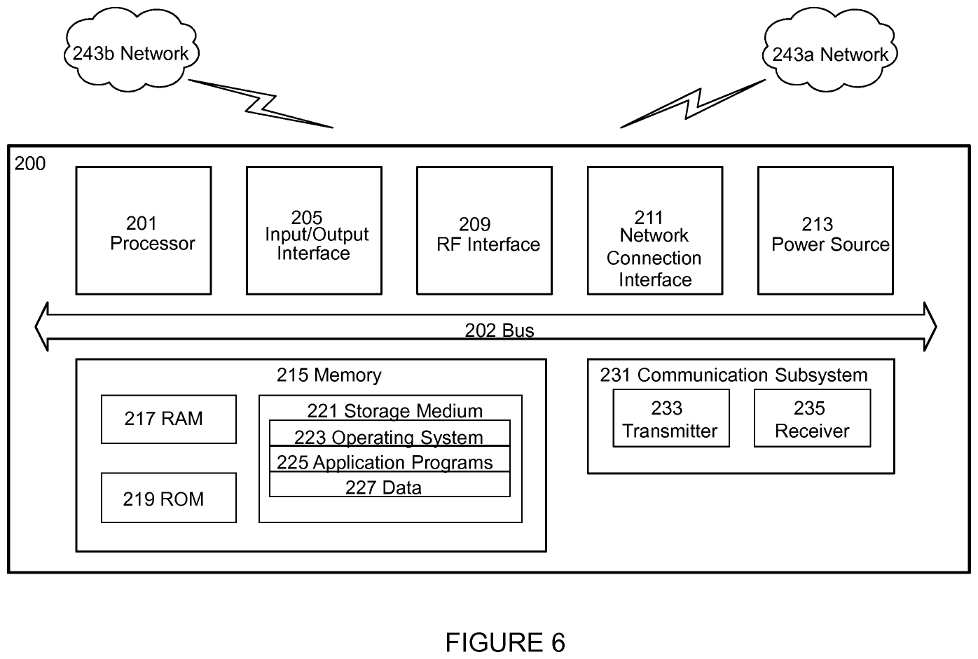

FIG. 6 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 6, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 6 is a UE, the components discussed herein are equally applicable to a WD, and vice-versa.

In FIG. 6, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 6, or only a subset of the components. The level of integration between the components may vary from one UE to another UE. Further, certain UEs may contain multiple instances of a component, such as multiple processors, memories, transceivers, transmitters, receivers, etc.

In FIG. 6, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 6, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 6, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

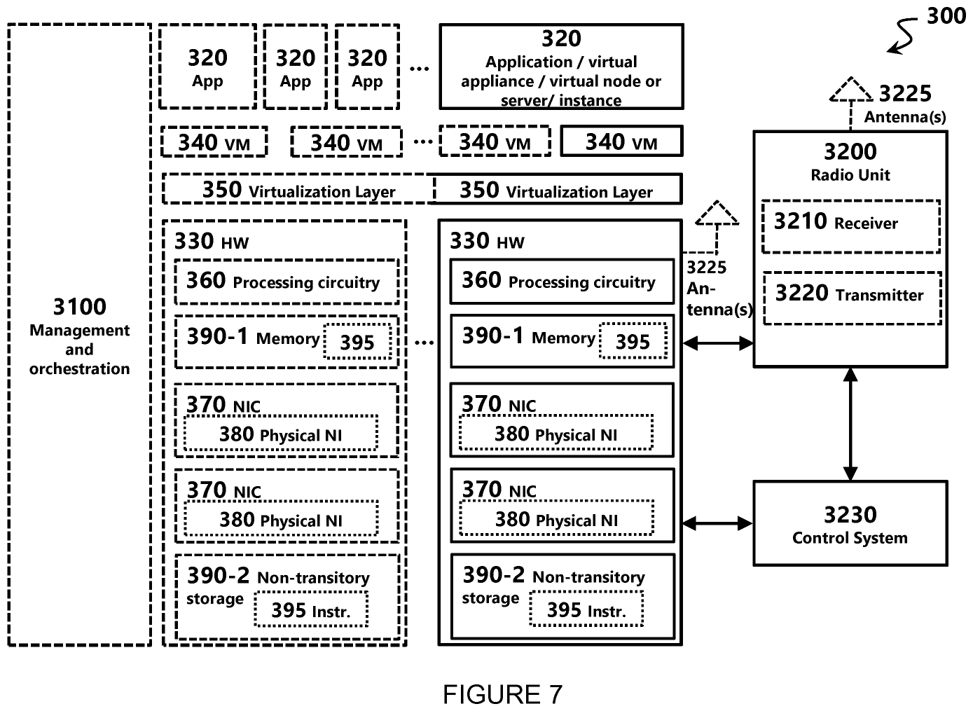

FIG. 7 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 7, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 7.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

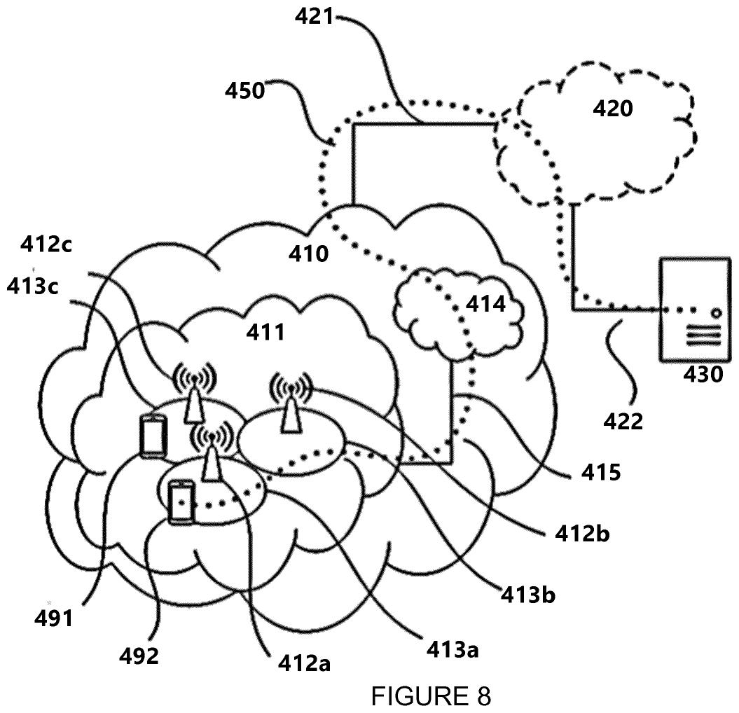

With reference to FIG. 8, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 8 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

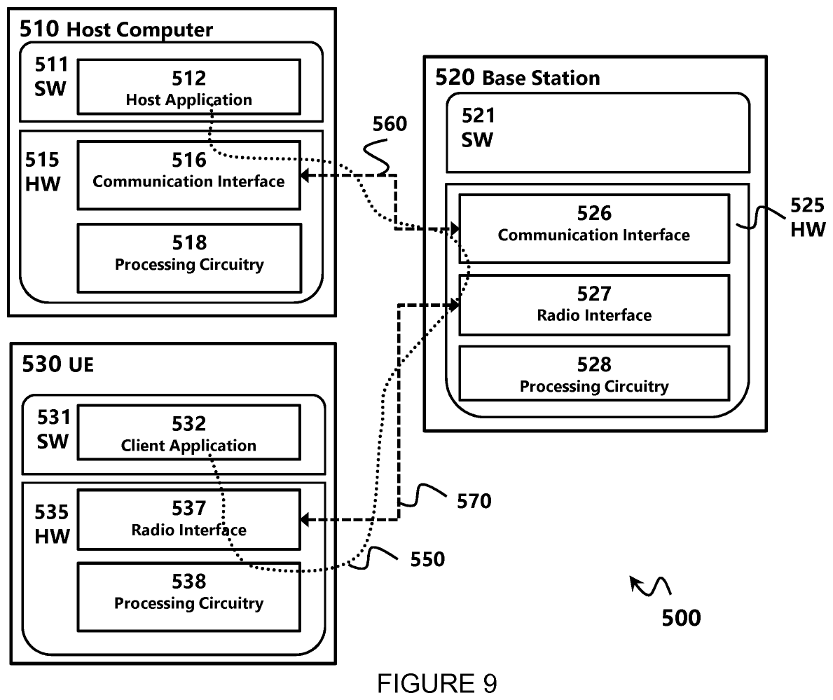

Example implementations, in accordance with an embodiment, of the UE, base station and host computer discussed in the preceding paragraphs will now be described with reference to FIG. 9. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 9) served by base station 520. Communication interface 526 may be configured to facilitate connection 560 to host computer 510. Connection 560 may be direct or it may pass through a core network (not shown in FIG. 9) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 9 may be similar or identical to host computer 430, one of base stations 412a, 412b, 412c and one of UEs 491, 492 of FIG. 8, respectively. This is to say, the inner workings of these entities may be as shown in FIG. 9 and independently, the surrounding network topology may be that of FIG. 8.

In FIG. 9, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the security of wireless connections and thereby provide benefits such as reducing the risk of data interception or collection.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

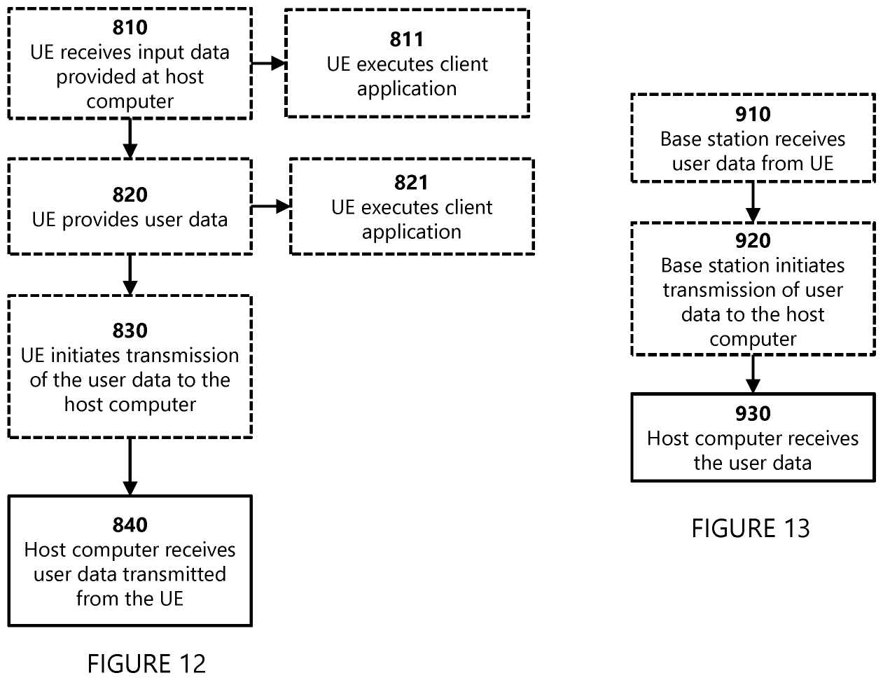

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

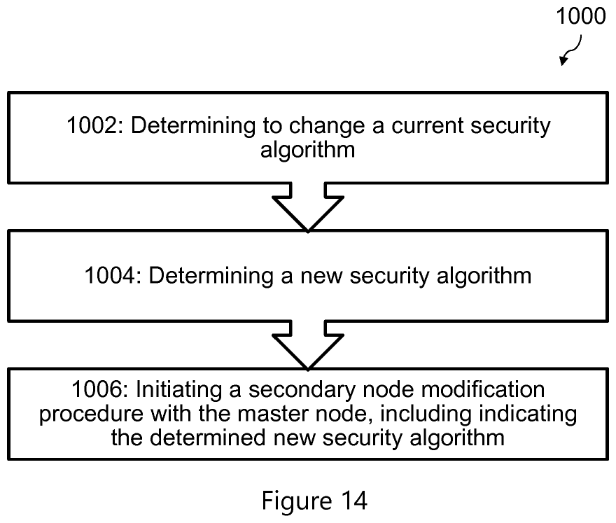

FIG. 14 depicts a method 1000 in accordance with particular embodiments, the method begins at step 1002 with determining to change a current security algorithm. For example, a secondary node (SN) may determine that the current security algorithm used to connect with a user equipment (UE) in dual connectivity with a master node, is not appropriate for the current wireless connection conditions. For example, the secondary node may determine that a more robust security algorithm can be accommodated due to a reduced load at the SN or alternatively, that a less strenuous security algorithm should be used based on the overload conditions at the SN.

Once determined that there should be a change in security algorithm, the method moves to step 1004 with determining a new security algorithm. For example, the SN may determine a new security algorithm to replace the current security algorithm for subsequent communication with the UE in dual connectivity. The determined new algorithm may be based on the load or other wireless conditions of the SN and/or UE.

The method may proceed to step 1006 with initiating a secondary node modification procedure with the master node. The initiating may include indicating the determined new security algorithm. For example, the SN may indicate the determined new security algorithm in the secondary node modification messaging. In this manner, the master node need not wait for the SN to respond to the modification request before sending the RRC connection reconfiguration messaging to the user equipment. The SN may indicate the determined new security algorithm in a new information element or may incorporate the indication into existing information elements. For example, the SN may send a modified PDCP change indication that includes a security algorithm update required indication and include the new security algorithm in the SCG Config information element. In this manner, the SN may initiate an update to the security algorithm(s) without detracting from the current efficient procedures for updating the security key and without causing redundant RRC connection reconfiguration messaging.

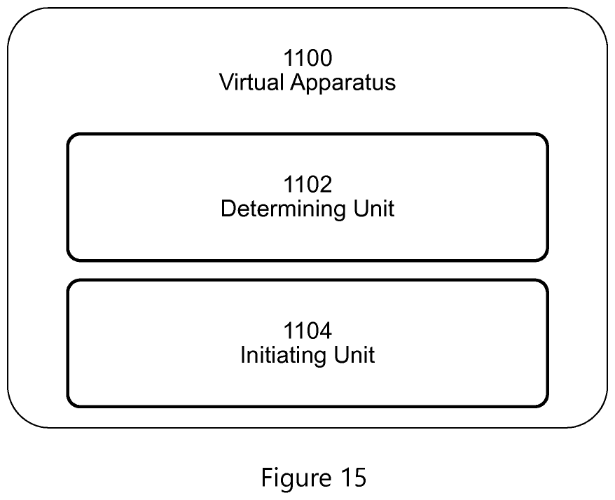

FIG. 15 illustrates a schematic block diagram of an apparatus 1100 in a wireless network (for example, the wireless network shown in FIG. 5). The apparatus may be implemented in a wireless device or network node (e.g., wireless device 110 or network node 160 shown in FIG. 5). Apparatus 1100 is operable to carry out the example method described with reference to FIG. 14 and possibly any other processes or methods disclosed herein. It is also to be understood that the method 1000 of FIG. 14 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining unit 1102, initiating unit 1104, and any other suitable units of apparatus 1100 to perform corresponding functions according one or more embodiments of the present disclosure.

As illustrated in FIG. 15, apparatus 1100 includes determining unit 1102 and initiating unit 1104. Determining unit 1102 is configured to determine to change a current security algorithm. For example, a secondary node (SN) may determine that the current security algorithm used to connect with a user equipment (UE) in dual connectivity with a master node, is not appropriate for the current wireless connection conditions. For example, the secondary node may determine that a more robust security algorithm can be accommodated due to a reduced load at the SN or alternatively, that a less strenuous security algorithm should be used based on the overload conditions at the SN. Determining unit 1102 may be further configured to determine a new security algorithm. For example, the SN may determine a new security algorithm to replace the current security algorithm for subsequent communication with the UE in dual connectivity. The determined new algorithm may be based on the load or other wireless conditions of the SN and/or UE.

Initiating unit 1104 may be configured to initiate a secondary node modification procedure with the master node. The initiating may include indicating the determined new security algorithm. For example, the SN may indicate the determined new security algorithm in the secondary node modification messaging. In this manner, the master node need not wait for the SN to respond to the modification request before sending the RRC connection reconfiguration messaging to the user equipment. The SN may indicate the determined new security algorithm in a new information element or may incorporate the indication into existing information elements. For example, the SN may send a modified PDCP change indication that includes a security algorithm update required indication and include the new security algorithm in the SCG Config information element. In this manner, the SN may initiate an update to the security algorithm(s) without detracting from the current efficient procedures for updating the security key and without causing redundant RRC connection reconfiguration messaging.

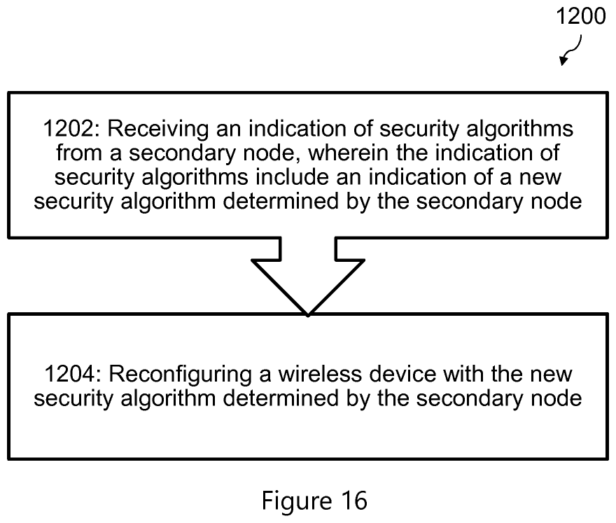

FIG. 16 depicts a method in accordance with particular embodiments, the method begins at step 1202 with receiving an indication of security algorithms from a secondary node. The security algorithms include an indication of a new security algorithm determined by the secondary node. For example, an SN may determine a change to the currently-used security algorithm and may provide an indication to the master node (MN) of the requested change. In this manner, the MN may receive an indication of a change of security algorithm(s) that is determined by the secondary node.

At step 1204, a wireless device may be reconfigured with the new security algorithm determined by the secondary node. For example, a master node in dual connectivity with the secondary node may send an RRC connection reconfiguration message to the wireless device using the new security algorithm. In this manner, the user equipment may be updated with the new security algorithm determined by the secondary node and use the new security algorithm in subsequent communications.

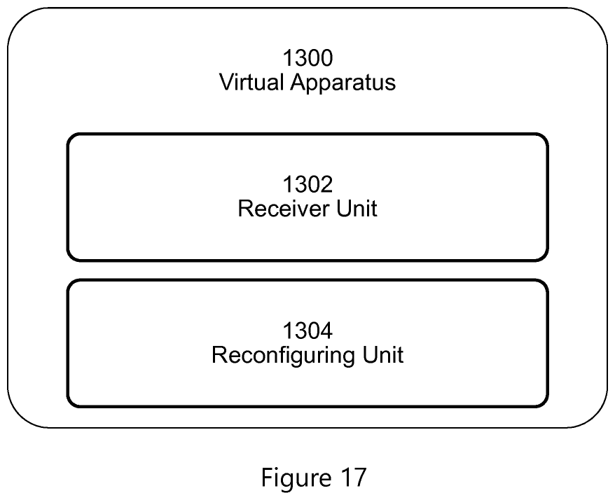

FIG. 17 illustrates a schematic block diagram of an apparatus 1300 in a wireless network (for example, the wireless network shown in FIG. 5). The apparatus may be implemented in a wireless device or network node (e.g., wireless device 110 or network node 160 shown in FIG. 5). Apparatus 1300 is operable to carry out the example method 1200 described with reference to FIG. 16 and possibly any other processes or methods disclosed herein. It is also to be understood that the method of FIG. 17 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiver unit 1302, reconfiguring unit 1304, and any other suitable units of apparatus 1300 to perform corresponding functions according one or more embodiments of the present disclosure.

As illustrated in FIG. 17, apparatus 1300 includes receiver unit WWB02 and reconfiguring unit 1304. Receiver unit 1302 is configured to receive an indication of security algorithms from a secondary node. The security algorithms include an indication of a new security algorithm determined by the secondary node. For example, an SN may determine a change to the currently-used security algorithm and may provide an indication to the master node (MN) of the requested change. In this manner, the MN may receive an indication of a change of security algorithm(s) that is determined by the secondary node.

Reconfiguring unit 1304 may be configured to reconfigure a user equipment with the new security algorithm determined by the secondary node. For example, a master node in dual connectivity with the secondary node may send an RRC connection reconfiguration message to the UE using the new security algorithm. In this manner, the user equipment may be updated with the new security algorithm determined by the secondary node and use the new security algorithm in subsequent communications.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

### SAMPLE EMBODIMENTS

### Group A Embodiments

1. A method performed by a wireless device for dual connectivity security handling, the method comprising:
   receiving reconfiguration messaging from a first network node; and
   communicating with a second network node based on the reconfiguration messaging
      wherein the reconfiguration messaging comprises an indication of a new security algorithm determined by the second network node.
2. The method of the previous embodiment, wherein the wireless device is in dual connectivity with the first network node as the master node and the second network node as the secondary node.
3. The method of the previous embodiment, wherein the dual connectivity is one of EN-DC and MR-DC with SGC.
4. The method of any of the previous embodiments, further comprising:
   providing user data; and
   forwarding the user data to a host computer via the transmission to the base station.

### Group B Embodiments

5. A method performed by a base station for dual connectivity security handling, the method comprising:
   determining to change a current security algorithm
   determining a new security algorithm; and
   initiating a secondary node modification procedure with a master node, including indicating the determined new security algorithm
6. The method of the previous embodiment, further comprising using the new security algorithm in communication with a wireless device in dual connectivity with the base station.
7. The method of any of the previous embodiments, wherein the base station is a secondary node in dual connectivity with a wireless device and a master node.
8. The method of the previous embodiment, wherein the dual connectivity is one of EN-DC and MR-DC with SGC.
9. The method of any of the previous embodiments, wherein indicating the determined new security algorithm comprises communicating one or more algorithm identifiers.
10. The method of the previous embodiment, wherein the algorithm identifiers are communicated in a secondary node modification required message.
11. The method of embodiment 9, wherein the algorithm identifiers are communicated in a SgNB modification required message.
12. A method performed by a base station for dual connectivity security handling, the method comprising:
   determining to change a current security algorithm
   determining a new security algorithm; and
   communicating an indication of the new security algorithm to a master node in response to a secondary node modification request.
13. The method according to the previous embodiment, wherein the secondary node modification request was sent by the master node
14. A method performed by a base station for dual connectivity security handling, the method comprising:
   determining to change a current security algorithm
   determining a new security algorithm;
   providing an indication that a new security algorithm will be provided when initiating a secondary node modification procedure to a master node; and
   communicating an indication of the new security algorithm to the master node in response to secondary node modification request.
15. A method performed by a base station for dual connectivity security handling, the method comprising:
   receiving an indication of security algorithms from a secondary node, wherein the security algorithms include an indication of a new security algorithm determined by the secondary node; and
   reconfiguring a wireless device with the new security algorithm determined by the secondary node.
16. The method of the previous embodiment, wherein the indication of security algorithms from the secondary node are received in response to a secondary node modification request.
17. The method of embodiment 17, further comprising reconfiguring the wireless device before receiving the indication of security algorithms from the secondary node.
18. The method of embodiment 17, further comprising delaying reconfiguring the wireless device until receiving the indication of security algorithms from the secondary node.
19. The method of embodiment 17, further comprising receiving an indication of a change in one or more security algorithms in a secondary node modification procedure initiation communication and wherein the indication of security algorithms from the secondary node are received in response to a secondary node modification request
20. The method of any of the previous embodiments, further comprising:
   obtaining user data; and
      forwarding the user data to a host computer or a wireless device.

### Group C Embodiments

21. A wireless device for dual connectivity security handling, the wireless device comprising:
   processing circuitry configured to perform any of the steps of any of the Group A embodiments; and
      power supply circuitry configured to supply power to the wireless device.
22. A base station for dual connectivity security handling, the base station comprising:
   processing circuitry configured to perform any of the steps of any of the Group B embodiments;
   power supply circuitry configured to supply power to the wireless device.
23. A user equipment (UE) for dual connectivity security handling, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
24. A computer program, the computer program comprising instructions which when executed on a computer perform any of the steps of any of the Group A embodiments.
25. A computer program product comprising a computer program, the computer program comprising instructions which when executed on a computer perform any of the steps of any of the Group A embodiments.
26. A non-transitory computer-readable storage medium or carrier comprising a computer program, the computer program comprising instructions which when executed on a computer perform any of the steps of any of the Group A embodiments.
27. A computer program, the computer program comprising instructions which when executed on a computer perform any of the steps of any of the Group B embodiments.
28. A computer program product comprising a computer program, the computer program comprising instructions which when executed on a computer perform any of the steps of any of the Group B embodiments.
29. A non-transitory computer-readable storage medium or carrier comprising a computer program, the computer program comprising instructions which when executed on a computer perform any of the steps of any of the Group B embodiments.
30. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
31. The communication system of the pervious embodiment further including the base station.
32. The communication system of the previous 2 embodiments, further including the UE, wherein the UE is configured to communicate with the base station.
33. The communication system of the previous 3 embodiments, wherein:
   the processing circuitry of the host computer is configured to execute a host application, thereby providing the user data; and
   the UE comprises processing circuitry configured to execute a client application associated with the host application.
34. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
35. The method of the previous embodiment, further comprising, at the base station, transmitting the user data.
36. The method of the previous 2 embodiments, wherein the user data is provided at the host computer by executing a host application, the method further comprising, at the UE, executing a client application associated with the host application.
37. A user equipment (UE) configured to communicate with a base station, the UE comprising a radio interface and processing circuitry configured to performs the of the previous 3 embodiments.
38. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
39. The communication system of the previous embodiment, wherein the cellular network further includes a base station configured to communicate with the UE.
40. The communication system of the previous 2 embodiments, wherein:
   the processing circuitry of the host computer is configured to execute a host application, thereby providing the user data; and
   the UE's processing circuitry is configured to execute a client application associated with the host application.
41. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
42. The method of the previous embodiment, further comprising at the UE, receiving the user data from the base station.
43. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
44. The communication system of the previous embodiment, further including the UE.
45. The communication system of the previous 2 embodiments, further including the base station, wherein the base station comprises a radio interface configured to communicate with the UE and a communication interface configured to forward to the host computer the user data carried by a transmission from the UE to the base station.
46. The communication system of the previous 3 embodiments, wherein:
   the processing circuitry of the host computer is configured to execute a host application; and
   the UE's processing circuitry is configured to execute a client application associated with the host application, thereby providing the user data.
47. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
48. A method implemented in a communication system including a host computer, a base station and a user equipment (UE), the method comprising:
   at the host computer, receiving user data transmitted to the base station from the UE, wherein the UE performs any of the steps of any of the Group A embodiments.
49. The method of the previous embodiment, further comprising, at the UE, providing the user data to the base station.
50. The method of the previous 2 embodiments, further comprising:
   at the UE, executing a client application, thereby providing the user data to be transmitted; and
   at the host computer, executing a host application associated with the client application.
51. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
52. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
53. The communication system of the previous embodiment further including the base station.
54. The communication system of the previous 2 embodiments, further including the UE, wherein the UE is configured to communicate with the base station.
55. The communication system of the previous 3 embodiments, wherein:
   the processing circuitry of the host computer is configured to execute a host application;
   the UE is configured to execute a client application associated with the host application, thereby providing the user data to be received by the host computer.
56. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
57. The method of the previous embodiment, further comprising at the base station, receiving the user data from the UE.
58. The method of the previous 2 embodiments, further comprising at the base station, initiating a transmission of the received user data to the host computer.

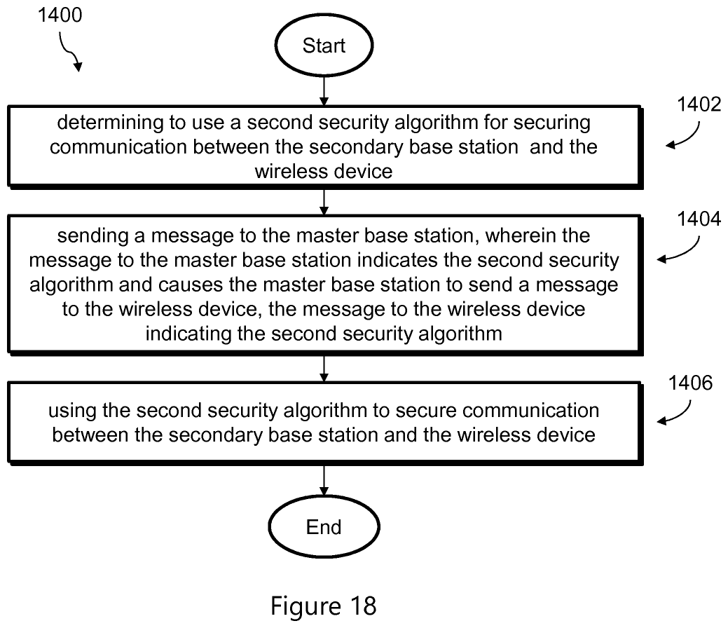

FIG. 18 illustrates an example method 1400 for use in a secondary base station, according to certain embodiments. For example, method 1400 may be used in a secondary base station (such as one of base stations 412 in FIG. 8 or base station 520 of FIG. 9) in first connection with a wireless device (such as wireless device 110 of FIG. 5) in a dual connectivity, wherein the wireless device has a second connection with a master base station (e.g., one of base stations 412 in FIG. 8 or base station 520 of FIG. 9), and wherein a first security algorithm is used for communication between the secondary base station and the wireless device in the first connection. According to certain embodiments, the dual connectivity is one of EN-DC and MR-DC.

At step 1402, the secondary base station may determine to use a second security algorithm for securing communication between the secondary base station and the wireless device. For example, the secondary base station may determine that the network conditions have changed and a new security algorithm may be better suited to the changed conditions. In certain embodiments, the second security algorithm may be different than the first security algorithm. As a particular example, if the first security algorithm was a null cipher algorithm, e.g., chosen because of network congestion or a high load on the secondary base station, the second security algorithm may be chosen to be a non-null cipher algorithm that is more secure. Conversely, if the network conditions worsen, the secondary base station may choose a less secure algorithm as the second algorithm to free up network resources to address the higher load.

Additionally, in some embodiments, the second security algorithm may be different from a security algorithm used between the master base station and the wireless device. For example, the secondary base station may determine the second security algorithm based on network conditions at the secondary base station that may be different from the network conditions at the master base station. Accordingly, the secondary base station may determine a different security algorithm as the second security algorithm than that used between the wireless device and the master base station.

In certain embodiments, the second security algorithm is used for an existing bearer between the wireless device and the secondary base station. Alternatively, in certain embodiments, the second security algorithm is used for an additional bearer between the wireless device and the secondary base station. The additional bearer being in addition to an existing bearer between the wireless device and the secondary base station. In such cases, the second security algorithm may be different from or the same as the first security algorithm.

At step 1404, the secondary base station may send a message to the master base station. The message to the master base station indicates the second security algorithm and causes the master base station to send a message to the wireless device. The message to the wireless device indicates the second security algorithm. In certain embodiments, the message sent to the master base station in step 1404 is a secondary base station modification required message comprising one or more algorithm identifiers associated with the new security algorithm. In some embodiments, the wireless device may be reconfigured to use the second security algorithm for communications with the secondary base station.

In certain embodiments, sending the message to the master base station is in response to determining, by the secondary base station, to initiate a security modification. Alternatively, in certain embodiments, the secondary base station receives, from the master base station, a security modification request. In these embodiments, sending the message to the master base station is in response to receiving the security modification request from the master base station. In some embodiments, in response to receiving the security modification request from the master base station, the secondary bases station sends the master base station an indication whether the secondary base station is going to be sending the message to the master base station that indicates the new security algorithm.

At step 1406, the secondary base station uses the second security algorithm to secure communication between the secondary base station and the wireless device. In this manner, the secondary base station may put a new security algorithm into use. For example, the secondary base station may change from a current security algorithm to a new security algorithm on an existing bearer, or the secondary base station may add a new security algorithm to be used on an additional bearer.

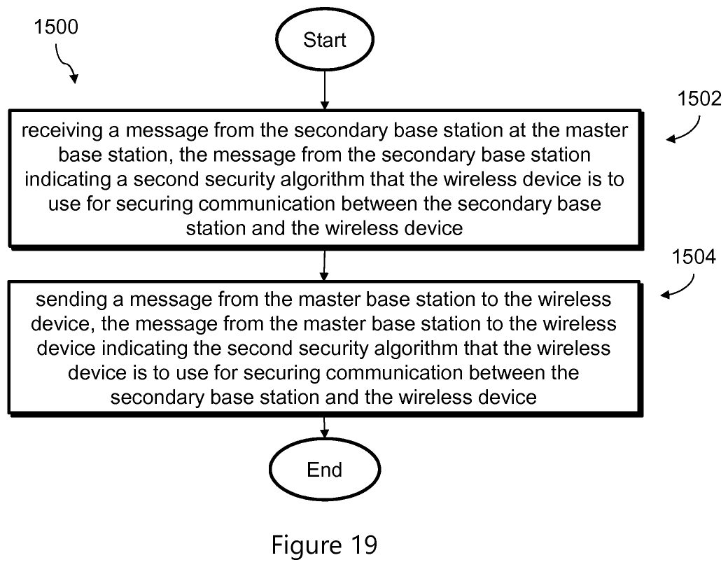

FIG. 19 illustrates an example method 1500 performed by a base station (such as one of base stations 160 of FIG. 5), according to certain embodiments. In certain embodiments, the base station is a mater master base station (such as MN 20 or 25 of FIG. 3 or 4, or one of base stations 160 of FIG. 5) in first connection with a wireless device (such as UE 10 or 15 of FIG. 3 or 4, or wireless device 110 of FIG. 5 or user equipment 200 in FIG. 6) in a dual connectivity. The wireless device may have a second connection with a secondary base station (such as SN 30 or 35 of FIG. 3 or 4, or one of base stations 160 of FIG. 5) and a first security algorithm is used for communication between the secondary base station and the wireless device in the second connection. In certain embodiments, the dual connectivity is one of EN-DC and MR-DC.

At step 1502, a message is received from the secondary base station at the master base station. The message from the secondary base station indicates a second security algorithm that the wireless device is to use for securing communication between the secondary base station and the wireless device. In certain embodiments, the message received from the secondary base station is a secondary base station modification required message comprising one or more algorithm identifiers associated with the second security algorithm. In certain embodiments, the second security algorithm is associated with an existing bearer between the wireless device and the secondary base station. Alternatively, in certain embodiments, the second security algorithm is associated with an additional bearer between the wireless device and the secondary base station. The additional bearer being in addition to an existing bearer between the wireless device and the secondary base station.

In certain embodiments, the second security algorithm may be different than the first security algorithm. Additionally, in some embodiments, the second security algorithm may be different from a security algorithm used between the master base station and the wireless device. For example, the secondary base station may determine the second security algorithm based on network conditions at the secondary base station that may be different from the network conditions at the master base station. Accordingly, the secondary base station may determine a different security algorithm as the second security algorithm than that used between the wireless device and the master base station.

The master base station, in step 1504, sends a message to the wireless device. The message indicates the second security algorithm that the wireless device is to use for securing communication between the secondary base station and the wireless device. In this manner, the master base station facilitates the addition of, or change to, a second security algorithm to be used with the wireless device and the secondary base station.

Method 1500 may include one or more additional and/or optional steps. For example, the master base station may further sending a security modification request to the secondary base station. For example, the security modification request may be sent after receiving the message from the secondary base station. The master base station may further wait to reconfigure the wireless device until after receiving an acknowledgement of the security modification request from the secondary base station. For example, if the wireless device is to use the second security algorithm for securing communication between the secondary base station and the wireless device, the acknowledgement comprises the message from the secondary base station indicating the second security algorithm. The master base station may reconfigure the wireless device after receiving the acknowledgement.

According to other embodiments, the master base station reconfigures the wireless device after sending the security modification request and without waiting for an acknowledgement of the security modification request from the secondary base station. The master base station may then receive an acknowledgement of the security modification request from the secondary base station. The acknowledgement comprises the message from the secondary base station indicating the second security algorithm. The master base station may reconfigure the wireless device again after receiving the acknowledgement.

According to other embodiments, the master base station further receives, from the secondary base station, an indication whether the secondary base station is going to be sending the message from the secondary base station indicating the second security algorithm that the wireless device is to use for securing communication between the secondary base station and the wireless device. The master base station reconfigures the wireless device by either waiting or not waiting for the message from the secondary base station. The waiting or not waiting is dependent on the indication whether the secondary base station is going to be sending the message. That is, if the secondary base station indicates that it is going to be sending the second security algorithm, the master base station waits to receive the second security algorithm before reconfiguring the wireless device. If the secondary base station indicates that it is not going to be sending the second security algorithm, the master base station proceeds with reconfiguring the wireless device (without waiting to receive a second security algorithm).

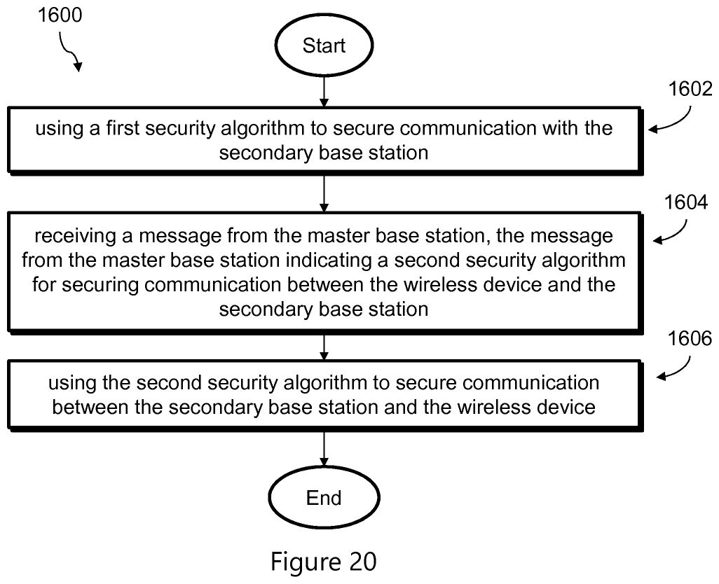

FIG. 20 illustrates an example method 1600 performed by a wireless device (such as UE 10 or 15 of FIG. 3 or 4, or wireless device 110 of FIG. 5 or user equipment 200 in FIG. 6). The wireless device may be in dual connectivity with a master base station and a secondary base station (e.g., two of base stations 412 in FIG. 8 or base station 520 of FIG. 9). The wireless device may have a first connection with the master base station and a second connection with the secondary base station. A first security algorithm is used for communication between the secondary base station and the wireless device in the second connection. In certain embodiments, the dual connectivity is one of EN-DC and MR-DC.

At step 1602, the wireless device uses a first security algorithm to secure communication with the secondary base station. For example, the first security algorithm may have been set up during the first configuration of the wireless device for communications with the secondary base station for dual connectivity or during a reconfiguration of the wireless device.

At step 1604, the wireless device receives a message from the master base station indicating a second security algorithm for securing communication between the wireless device and the secondary base station. In certain embodiments, the message from the master base station comprises an RRC reconfiguration message that includes one or more algorithm identifiers associated with the second security algorithm.

In certain embodiments, the second security algorithm may be different than the first security algorithm. Additionally, in some embodiments, the second security algorithm may be different from a security algorithm used between the master base station and the wireless device. For example, the secondary base station may determine the second security algorithm based on network conditions at the secondary base station that may be different from the network conditions at the master base station. Accordingly, the secondary base station may determine a different security algorithm as the second security algorithm than that used between the wireless device and the master base station.

At step 1606, the wireless device uses the second security algorithm to secure communication between the secondary base station and the wireless device. For example, the wireless device may determine the second security algorithm from one or more algorithm identifies in an RRC reconfiguration message in the message from the master base station and apply it in establishing communication with the secondary base station. In certain embodiments, the second security algorithm is used for an existing bearer between the wireless device and the secondary base station. Alternatively, in certain embodiments, the second security algorithm is used for an additional bearer between the wireless device and the secondary base station. The additional bearer being in addition to an existing bearer between the wireless device and the secondary base station. In this manner, the wireless device updates its security algorithm used with the secondary base station.

1.-54. (canceled)

55. A method performed by a wireless device, which is in dual connectivity with a master base station and a secondary base station, wherein the wireless device has a first connection with the master base station and a second connection with the secondary base station, and wherein a first security algorithm is used for communication between the secondary base station and the wireless device in the second connection, the method comprising:
using the first security algorithm to secure communication with the secondary base station;
receiving a message from the master base station, the message from the master base station indicating a second security algorithm for securing communication between the wireless device and the secondary base station; and
using the second security algorithm to secure communication between the secondary base station and the wireless device, wherein the second security algorithm is used for an additional bearer between the wireless device and the secondary base station, the additional bearer in addition to an existing bearer between the wireless device and the secondary base station.

56. A secondary base station comprising processing circuitry configured to:
establish a first connection with a wireless device in a dual connectivity, wherein the wireless device has a second connection with a master base station, and wherein a first security algorithm is used for communication between the secondary base station and the wireless device in the first connection;
determine to use a second security algorithm for securing communication between the secondary base station and the wireless device;
send a message to the master base station, wherein the message to the master base station indicates the second security algorithm and causes the master base station to send a message to the wireless device, the message to the wireless device indicating the second security algorithm; and
use the second security algorithm to secure communication between the secondary base station and the wireless device, wherein the second security algorithm is used for an additional bearer between the wireless device and the secondary base station, the additional bearer in addition to an existing bearer between the wireless device and the secondary base station.

57. The secondary base station of claim 56, wherein the secondary base station sends the message to the master base station in response to determining, by the secondary base station, to initiate a security modification.

58. The secondary base station of claim 56, wherein the secondary base station is further configured to:
receive, from the master base station, a security modification request;
wherein the secondary base station sends the message to the master base station in response to receiving the security modification request from the master base station.

59. The secondary base station of claim 56, wherein the dual connectivity is one of Evolved Terrestrial Radio Access-New Radio Dual Connectivity, EN-DC, and Multi-Radio Access Technology Dual Connectivity, MR-DC.

60. The secondary base station of claim 56, wherein the message sent to the master base station is a secondary base station modification required message comprising one or more algorithm identifiers associated with the second security algorithm.

61. The secondary base station of claim 56, wherein the second security algorithm is not the same as the first security algorithm.

62. The secondary base station of claim 56, wherein the second security algorithm is not the same as a security algorithm used in the second connection between the wireless device and the master base station.

63. A master base station comprising processing circuitry configured to:
establish a first connection with a wireless device in a dual connectivity, wherein the wireless device has a second connection with a secondary base station, and wherein a first security algorithm is used for communication between the secondary base station and the wireless device in the second connection;
receive a message from the secondary base station at the master base station, the message from the secondary base station indicating a second security algorithm that the wireless device is to use for securing communication between the secondary base station and the wireless device; and
send a message from the master base station to the wireless device, the message from the master base station to the wireless device indicating the second security algorithm that the wireless device is to use for securing communication between the secondary base station and the wireless device, wherein the second security algorithm is associated with an additional bearer between the wireless device and the secondary base station, the additional bearer in addition to an existing bearer between the wireless device and the secondary base station.

64. The master base station of claim 63, further configured to:
send a security modification request to the secondary base station;
wait to reconfigure the wireless device until after receiving an acknowledgement of the security modification request from the secondary base station, wherein, if the wireless device is to use the second security algorithm for securing communication between the secondary base station and the wireless device, the acknowledgement comprises the message from the secondary base station indicating the second security algorithm; and
reconfigure the wireless device after receiving the acknowledgement.

65. The master base station of claim 63, further configured to:
send a security modification request to the secondary base station;
receive, from the secondary base station, an indication whether the secondary base station is going to be sending the message from the secondary base station indicating the second security algorithm that the wireless device is to use for securing communication between the secondary base station and the wireless device; and
reconfigure the wireless device by either waiting or not waiting for the message from the secondary base station, the waiting or not waiting depending on the indication whether the secondary base station is going to be sending the message.

66. The master base station of claim 63, wherein the message received from the secondary base station is a secondary base station modification required message comprising one or more algorithm identifiers associated with the second security algorithm.

67. The master base station of claim 63, wherein the second security algorithm is not the same as a security algorithm used in the first connection between the wireless device and the master base station.

68. A wireless device comprising processing circuitry configured to:
establish dual connectivity with a master base station and a secondary base station, wherein the wireless device has a first connection with the master base station and a second connection with the secondary base station;
use a first security algorithm to secure communication with the secondary base station;
receive a message from the master base station, the message from the master base station indicating a second security algorithm for securing communication between the wireless device and the secondary base station; and
use the second security algorithm to secure communication between the secondary base station and the wireless device, wherein the second security algorithm is used for an additional bearer between the wireless device and the secondary base station, the additional bearer in addition to an existing bearer between the wireless device and the secondary base station.

69. The wireless device of claim 68, wherein the second security algorithm is used for an existing bearer between the wireless device and the secondary base station.

70. wireless device of claim 68, wherein the second security algorithm is used for an additional bearer between the wireless device and the secondary base station, the additional bearer in addition to an existing bearer between the wireless device and the secondary base station.

71. The wireless device of claim 68, wherein the dual connectivity is one of Evolved Terrestrial Radio Access-New Radio Dual Connectivity, EN-DC, and Multi-Radio Access Technology Dual Connectivity, MR-DC.

72. The wireless device of claim 68, wherein the message from the master base station comprises a radio resource control, RRC, reconfiguration message, the RRC reconfiguration message comprising one or more algorithm identifiers associated with the second security algorithm.

73. The wireless device of claim 68, wherein the second security algorithm is not the same as the first security algorithm.

74. The wireless device of claim 68, wherein the second security algorithm is not the same as a security algorithm used in the first connection between the wireless device and the master base station.
